(19) United States
(12) Patent Application Publication
(10) Pub. No.: US 2011/0180194 A1
(43) Pub. Date: Jul. 28, 2011

(54) RUN-FLAT DEVICE

(75) Inventors: Brian Anderson, Wausau, WI (US); Mike Tercha, Weston, WI (US); Ali Manesh, Chicago, IL (US); Karen Hauch, Wausau, WI (US); Glenn Howland, Kronenwetter, WI (US); Todd Petersen, Ringle, WI (US); Fidelis Ceranski, Marathon, WI (US); Louis Stark, Mosinee, WI (US); Brian Meliska, Weston, WI (US)

(73) Assignee: RESILIENT TECHNOLOGIES, LLC, Wausau, WI (US)

(21) Appl. No.: 13/121,508

(22) PCT Filed: Sep. 28, 2009
(86) PCT No.: PCT/US2009/058652

§ 371 Date: Mar. 29, 2011

Related U.S. Application Data
(63) Continuation-in-part of application No. 12/240,918, filed on Sep. 29, 2008.

(51) Int. Cl. B60C 17/06

(52) U.S. Cl. 152/520

(57) ABSTRACT

A run-flat device, which is inserted into pneumatic tires to allow mobility in the event of pressure loss in the pneumatic tire, can comprise an inner ring, outer ring, and an interconnected web connecting the two. The run-flat device can support an applied load by working in tension and compression.

### CLAIM OF PRIORITY

This application is a Continuation-In-Part from U.S. application Ser. No. 12/240,913, filed Sep. 29, 2008, incorporated in its entirety be reference herein.

### BACKGROUND OF THE INVENTION

1. Field of the Invention

The present application is directed to a run-flat device that is inserted into a tire.

2. Description of the Related Art

Run-flat devices allow continued use of a vehicle riding on pneumatic tires in the event that the pneumatic tires are damaged and unable to carry the required load. There are many types of run-flat devices. Most run-flat devices comprise a solid elastomer or rigid metal design that is positioned within an outer shell of the pneumatic tire. Solid elastomer run-flat tires are difficult to install due to their one-piece design and the rigidity of the bead steel in pneumatic tires. Such run-flat devices are also heavy due to their solid design. These run-flat devices therefore add rotating and static mass to the entire wheel assembly. The solid run-flat devices also provide little cushion, resulting in a rough ride, which can damage the vehicle.

Rigid metal designs are typically easier to assemble since they can be made in several pieces but have even less cushion as compared to solid elastomer designs. The increased stiffness with rigid metal designs can also cause problems when the inflated tire is subjected to impact loads or obstacles at speed. In addition, if the run-flat device with a rigid metal design is deformed enough to reach the run-flat, the sudden impact can subject the suspension and vehicle to unacceptable accelerations.

Another type of run-flat tire device relies on providing the tire with a thick side wall that provides structural support when the tire loses air pressure. However, the thick sidewall results in a harsher ride during normal, pneumatic operation. Such thick sidewall tires also have a limited lifetime after puncture due to the heat generated by the flexing of the sidewall during operations. The event that caused the tire to lose pressure can also affect the structural integrity of the side wall.

### SUMMARY OF THE INVENTION

Accordingly, there is a general need to provide an improved run-flat device that addresses one or more of the problems discussed above. Accordingly, in one arrangement of the present invention there is provided a run-flat insert for insertion into a pneumatic tire. The insert can comprise an inner ring, outer ring, and interconnected web connecting the inner and outer rings. The inner ring can hold the beads of a pneumatic tire in place, such that the run-flat is located within the inflated pneumatic portion of the pneumatic tire during its use.

Another arrangement comprises a run-flat device for use with a pneumatic tire that includes an inner ring having an axis of rotation. The inner ring comprises at least two annular pieces. The device also includes a deformable outer ring that includes at least two annular pieces. A flexible interconnected web extends between the inner and outer ring and comprising at least two annular pieces. The interconnected web comprises at least two radially adjacent layers of web elements at every radial cross-section of the run-flat device. The web elements define a plurality of generally polygonal openings and comprises at least one radial web element that is angled relative to a plane that extends radially through the axis of rotation. A substantial amount of load is supported by a plurality of the web elements working in at least in part tension when the run-flat device is in direct contact with the ground.

Another arrangement comprise a pneumatic tire that includes a rim and an annular inner ring coupled to the rim. An interconnected web is coupled to the inner ring. The interconnected web comprises a plurality of polygonal shaped web elements and openings. The polygonal shaped web elements are stronger in tension than in compression. An annular outer ring is attached to the interconnected web on a side of the interconnected web opposite that of the annular inner ring. The annular outer ring comprises a deformable material. An external pneumatic tire is operatively coupled to the rim.

### BRIEF DESCRIPTION OF THE DRAWINGS

FIG. 1 is a top, front, and left side perspective view of an embodiment of a run-flat device.

FIG. 2 is a bottom plan view of an embodiment of a run-flat device.

FIG. 3 is a right side elevational view of an embodiment of a run-flat device.

FIG. 4 is a front side elevational view of an embodiment of a run-flat device.

FIG. 4A is a front view of another embodiment of a run-flat device.

FIG. 4B is a front view of another embodiment of a run-flat device.

FIG. 4C is a front view of another embodiment of a run-flat device.

FIG. 4D is a front view of another embodiment of a run-flat device.

FIG. 4E is a front view of another embodiment of a run-flat device.

FIG. 4F is a front view of another embodiment of a run-flat device.

FIG. 4G is a front view of another embodiment of a run-flat device.

FIG. 4H is a perspective view of an embodiment of a run-flat device with circumferentially offset segments.

FIG. 4I is a top, front, and left side perspective view of another embodiment of a run-flat device.

FIG. 5A is a sectional view of a prior art tread carrying portion.

FIG. 5B is a sectional view of another prior art tread carrying portion.

FIG. 5C is a sectional view of another prior art tread carrying portion.

FIG. 6 is a top, front, and left side perspective view of another embodiment of a run-flat device.

FIG. 6A is a top, front, and left side perspective view of another embodiment of a run-flat device.

FIG. 6B is a top, front, and left side perspective view of another embodiment of a run-flat device.

FIG. 6C is a top, front, and left side perspective view of another embodiment of a run-flat device.

FIG. 6D is a top, front, and left side perspective view of another embodiment of a run-flat device.

FIG. 7 is a partial top, front, and left side perspective view of another embodiment of a run-flat device.

FIG. 8 is a perspective view of flexible links which can be used in an embodiment of a run-flat device.

FIG. 9 is a sectional view of the flexible links of FIG. 8 in use.

FIG. 10A is a partial view of a bolt flange and interference joint.

FIG. 10B is a partial view of bolt flange and interference joint.

FIG. 11 is a top, front, and left side perspective view of another embodiment of a run-flat device.

FIG. 12 is a perspective view of an embodiment of a run-flat insert attached within a pneumatic tire, the pneumatic tire having a cutout portion on top to reveal the run-flat insert.

### DETAILED DESCRIPTION OF THE PREFERRED EMBODIMENTS

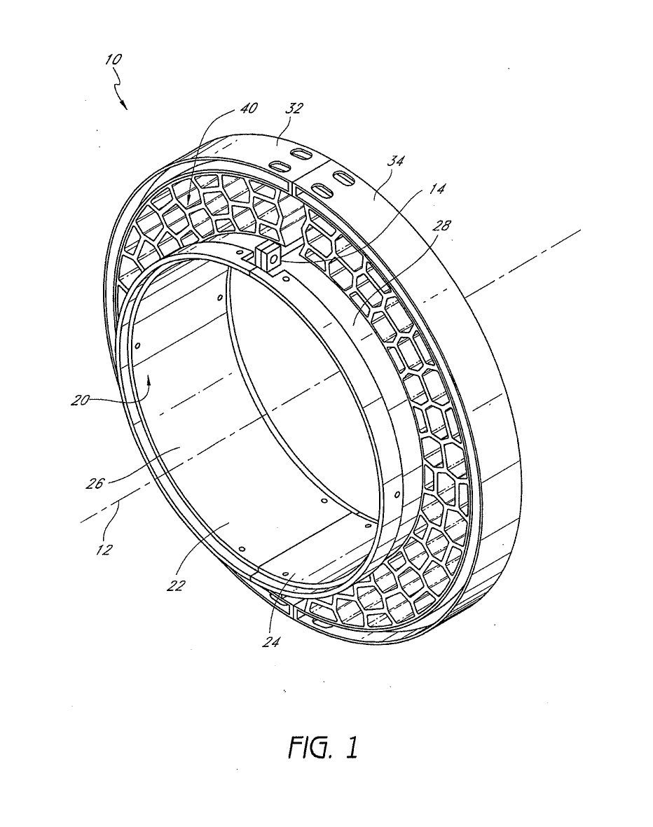

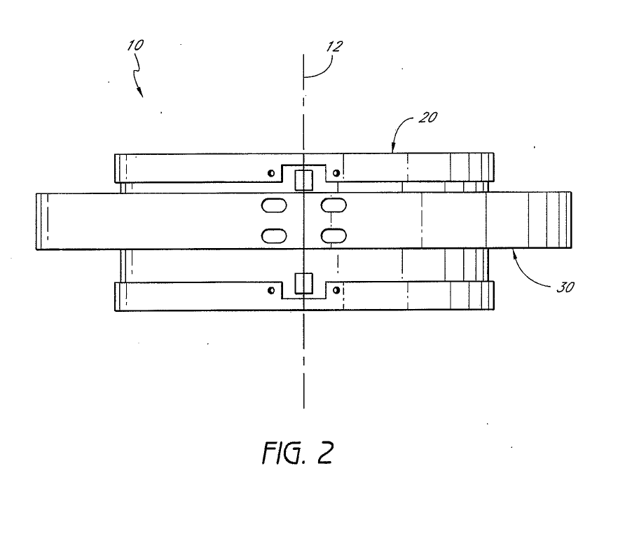

FIGS. 1-4 illustrate one embodiment of a run-flat device 10 for supporting load after a pneumatic tire failure. With initial reference to FIGS. 1, 2 and 3, the run-flat device 10 can generally comprise an inner ring 20, an outer ring 30, and an interconnected web 40 that connects the inner ring 20 and outer ring 30.

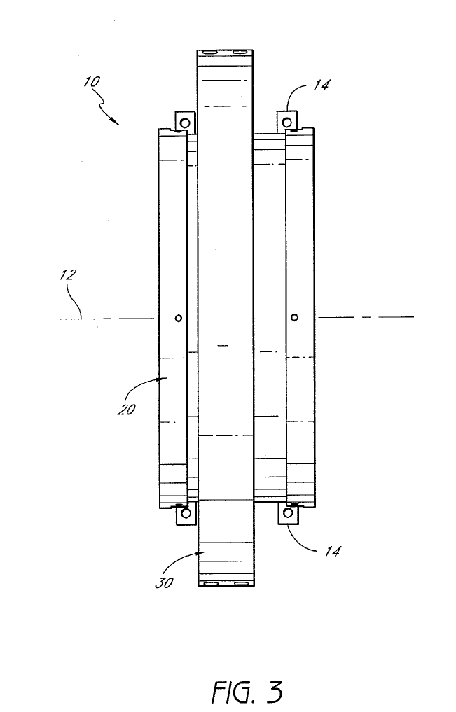

The generally annular inner ring 20 can comprise an internal surface 26 and an external surface 28. In a preferred arrangement, the inner ring 20 is configured to be coupled to a rim (not shown) of a tire with an axis of rotation 12. In the illustrated embodiment, the inner ring 20 is divided into two semi-circular parts 22, 24. In this manner, the inner ring 20 can be inserted over the rim of a tire by bringing the two parts 22, 24 together. Once placed around the rim of the tire, the inner ring 20 can be coupled to the rim of the tire in various manners, including, but not limited to, fasteners, additional clamping devices, adhesives, bonding and/or any combination thereof. In the illustrated embodiment, the inner ring 20 can be supplied with a pair of bolt flanges 14 (See FIG. 3). In this manner, bolts (not shown) can be used with the flanges 14 to secure the two-piece inner ring 12 about the rim of the tire. In one embodiment, the inner ring 20 can be used to attach the beads of a pneumatic tire via compression between the inner ring 20 and the rim.

The inner ring 20 can be made of metal, polymer, or other suitable material. As noted above, in the illustrated embodiment, the inner ring 20 can be formed by combining two pieces together. In other embodiments, the inner ring 20 can be formed by more than two pieces. In other embodiments, the inner ring 20 can be formed from a single piece that is slipped over the rim of the tire (e.g., through a press or slip fit) or otherwise positioned around the rim of the tire.

With continued reference to FIGS. 1-4, the outer ring 30 can be made of metal, polymer, or other suitable material, and in some embodiments can be deformable. The polymer can be, for example, a thermoplastic, such as a thermoplastic elastomer a thermoplastic urethane, or a thermoplastic vulcanizate. “Polymer,” as referred to herein, refers to both cross-linked and/or uncross-linked polymers. The outer ring 30 can also be made of rubber, polyurethane, and/or any other suitable material. As will be explained below, the outer ring 30 is advantageously stiff enough to distribute some load from the footprint region of the interconnected web 40 to the rest of the web. That is, in one embodiment, the outer ring 30 is configured to deform in an area around and including a footprint region (not shown) of the tire 10. This arrangement decreases vibration and increases ride comfort.

The outer ring 30 can have a section in the shape of an I-beam, box, C-channel, or any other shape that provides bending stiffness. In the illustrated embodiment, the outer ring 30 comprises an inner portion and an outer portion, the inner and outer portions forming two C-channels around the interconnected web 40. Both the inner and outer portions of the outer ring 30 can be formed from the same, or different, material. In one embodiment, the parts of the inner and outer rings are bolted together, but in other embodiments, they can be joined by adhesives and/or other coupling structures and/or provided within interlocking joints.

As with the inner ring 20, the outer ring 30 can be made as pieces such that it can be inserted around an existing rim of a tire. In the illustrated embodiment, the outer ring comprises two pieces 32 and 34. The outer ring 30 can be coupled to the rim of the tire in various manners, including, but not limited to, fasteners, additional clamping devices, adhesives, bonding and/or any combination thereof. For example, the outer ring 30 can be supplied with a pair of bolt flanges (not shown). In this manner, bolts (not shown) can be used with the flanges to secure the two-piece inner ring 12 about the rim of the tire. In one embodiment, the web 40 and outer ring 30 are formed together with corresponding pieces of the inner ring 20. In this manner, the mechanism used to secure the inner ring 20, web 40, or outer ring 30 together can be used to secure the other remaining parts together. In other embodiments, parts of the web 40 do not need to be coupled together across a joint but only secured between the inner and outer rings 30. In still other embodiments, the outer ring 30 can be formed in more than two pieces. In other embodiments, the outer ring 30 can be formed into a single piece.

In other embodiments, the outer ring 30 can be made of, or include, rubber and/or belts. For example, the outer ring 30 can have a radially external surface to which a rubber tread carrying layer is attached as described below. Attachment of the tread carrying layer to the outer ring 30 can be accomplished adhesively, for example, or by using other methods commonly available in the art. As described below, in some embodiments, the tread carrying layer can comprise embedded reinforcing belts to add increased overall stiffness to the run-flat device 10, wherein the embedding of the reinforcing belts is accomplished according to methods commonly available in the art. Reinforcing belts can be made of steel or other strengthening materials.

In still other embodiments, a friction and/or wear reducing element can be provided over the outer ring 30. The purpose of such an element is to reduce the friction and/or wear of the run-flat device 10 against the inside of the tire that has been damaged. In one embodiment, a polyurethane ring can be molded or otherwise positioned over the outer ring 30. Such a ring can include tread-like patterns or be generally smooth.

In one embodiment, the generally annular inner ring 20 and a generally annular outer ring 30 are made of the same material as the interconnected web 40. In such an embodiment, the generally annular inner ring 20, generally annular outer ring 30, and the interconnected web 40 can be made by injection or compression molding, castable polymer, or any other method generally known in the art; and can be formed at the same time so that their attachment is formed by the material comprising the inner ring 20, the outer ring 30, and the interconnected web 40 cooling and setting. In such embodiments, the inner ring 20, an outer ring 30 and web 40 can be formed in one or more pieces as described above. In other embodiments, the web 40 can be formed with the inner ring 20 or with the outer ring 30 to form a subcomponent.

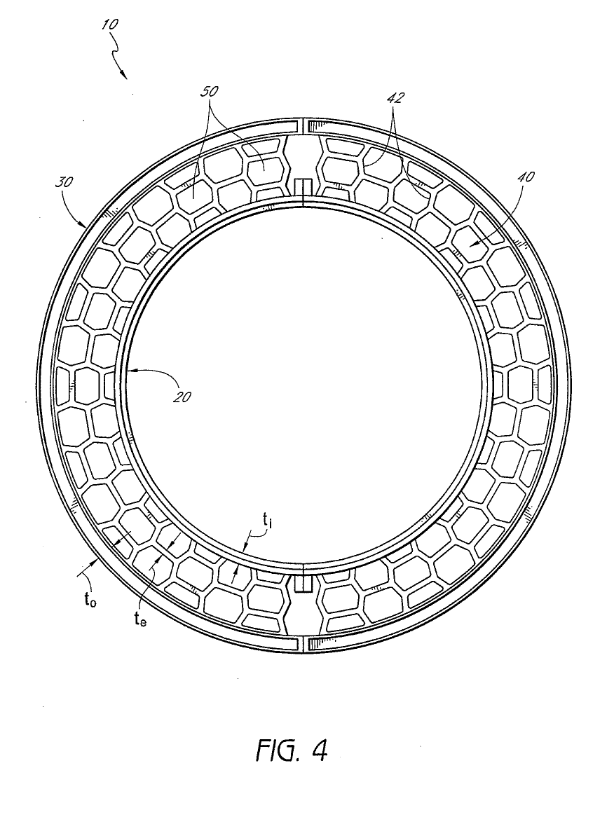

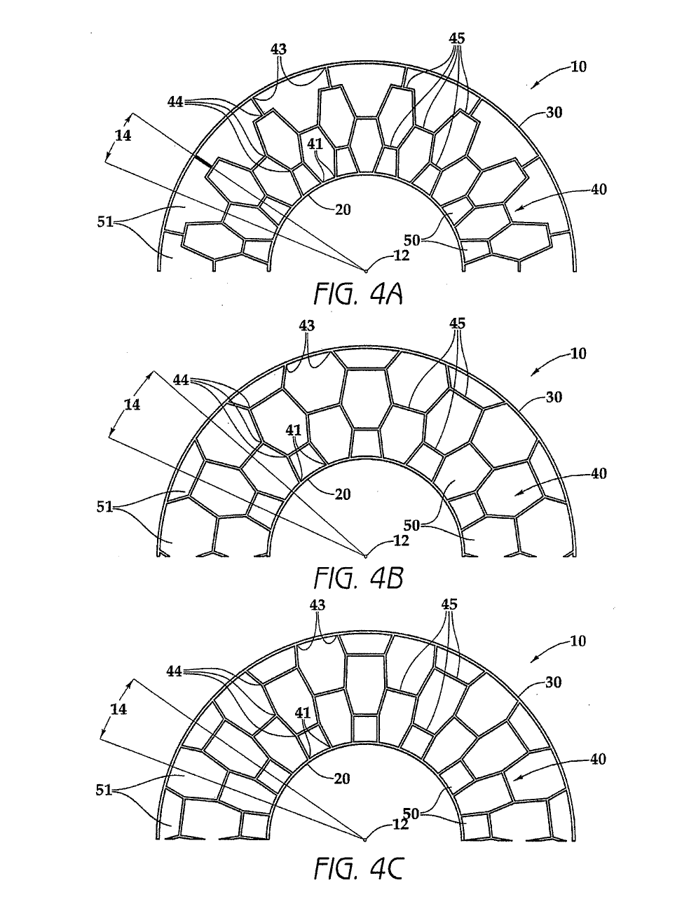

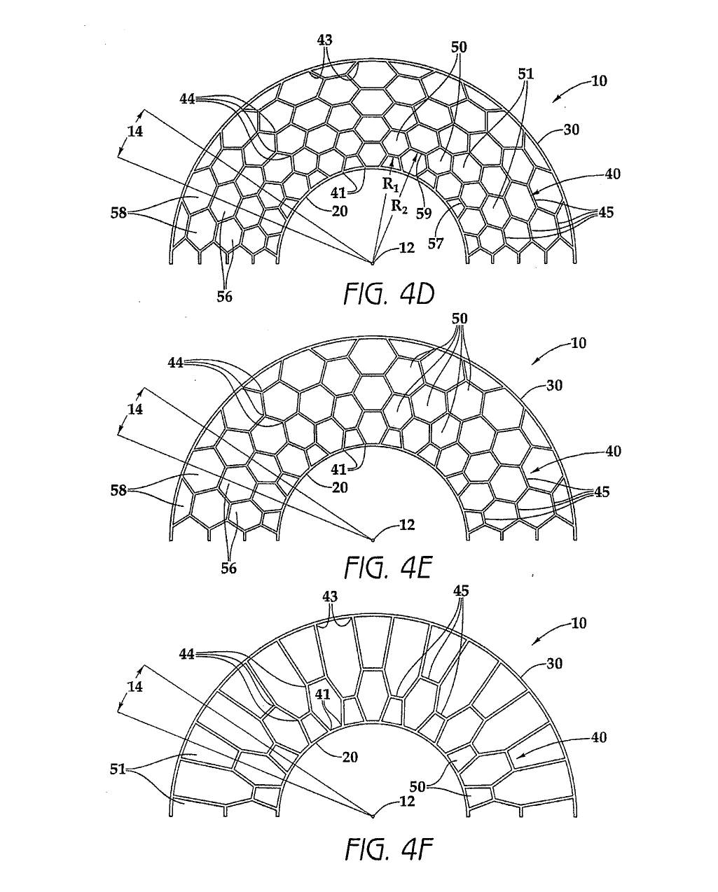

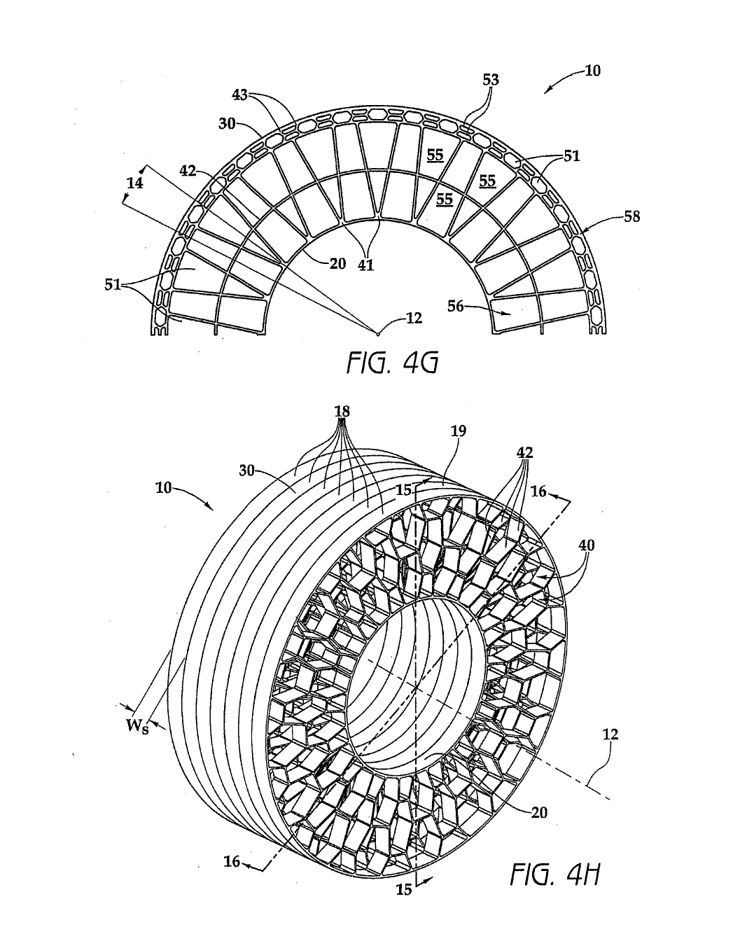

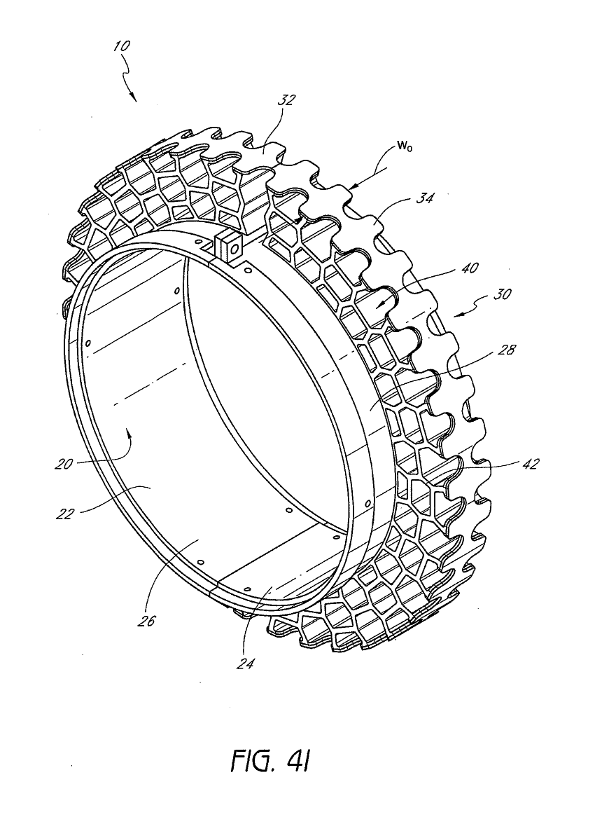

With reference to FIGS. 1-4H, and incorporating by reference herein the entirely of U.S. patent application Ser. Nos. 11/691,968 (RSLNT.001A) and U.S. patent application Ser. No. 12/055,675 (RSLNT.001CP1), the interconnected web 40 of the run-flat device 10 connects the generally annular inner ring 20 to the generally annular outer ring 30. With reference to FIG. 4D, the interconnected web 40 comprises at least two radially adjacent layers 56, 58 of web elements 42 that define a plurality of generally polygonal openings 50. In other words, with at least two adjacent layers 56, 58, a slice through any radial portion of the run-flat device 10 extending from the axis of the rotation 12 to the generally annular outer ring 30 passes through or traverses at least two generally polygonal openings 50. The polygonal openings 50 can form various shapes, some of which are shown in FIGS. 4-4H. In many embodiments, a majority of generally polygonal openings 50 can be generally hexagonally shaped with six sides. However, it is possible that each one of the plurality of generally polygonal openings 50 has at least three sides. In one embodiment, the plurality of generally polygonal openings 50 are either generally hexagonal in shape or hexagonal in shape circumferentially separated by openings that are generally trapezoidal in shape, as can be seen in FIG. 4A, giving the interconnected web 40 a shape that can resemble a honeycomb.

A preferred range of angles between any two interconnected web elements (moving radially from the tread portion of the tire to the wheel) can be between 60 and 180 degrees (See, for example, the web elements of FIG. 4A). Other ranges are also possible.

With continued reference to the illustrated embodiments of FIGS. 4-4H, the interconnected web 40 can be arranged such that one web element 42 connects to the generally annular inner ring 20 at any given point or line along the generally annular inner ring 20 such that there are a first set of connections 41 along the generally annular inner ring 20. Likewise, one web element 42 can connect to the generally annular outer ring 30 at any given point or line along an internal surface of the generally annular outer ring 30 such that there are a second set of connections 43 along the generally annular outer ring 30. However, more than one web element 42 can connect to either the generally annular inner ring 20 or to the generally annular outer ring 30 at any given point or line.

As shown in FIGS. 4-4H, the interconnected web 40 can further comprise intersections 44 between web elements 42 in order to distribute applied load, L, throughout the interconnected web 40. In these illustrated embodiments, each intersection 44 joins at least three web elements 42. However, in other embodiments, the intersections 44 can join more than three web elements 42, which can assist in further distributing the stresses and strains experienced by web elements 42.

With continued reference to FIGS. 4-4H, the web elements 42 can be angled relative to a radial plane 16 containing the axis of rotation 12 that also passes through web element 42. By angling the web elements 42, applied load, L, which is generally applied perpendicular to the axis of rotation 12, can be eccentrically applied to the web elements 42. This can create a rotational or bending component of an applied load on each web element 42, facilitating buckling of those web elements 42 subjected to a compressive load. Similarly situated web elements 42 can all be angled by about the same amount and in the same direction relative to radial planes 16. Preferably, however, the circumferentially consecutive web elements 42, excluding tangential web elements 45, of a layer of plurality of generally polygonal openings 50 are angled by about the same magnitude but measured in opposite directions about radial planes, such that web elements 42 are generally mirror images about radial plane 16 of one another.

Each of the openings within the plurality of generally polygonal tubular openings 50 can, but is not required, to be similar in shape. FIG. 4D, for example, shows a first plurality of generally polygonal openings 50 that is different in shape from a second plurality of generally polygonal openings 51. In this embodiment, at least one opening of the first plurality of general polygonal openings 50 can be smaller than at least one opening of the second plurality of generally polygonal openings 51. FIG. 4D also shows that each generally polygonal opening in the first plurality of generally polygonal openings 50 has an inner boundary 57 spaced a radial distance, R₁, from axis of rotation 12 and each generally polygonal opening in the second plurality of generally polygonal openings 51, has a second inner boundary 59 spaced a radial distance, R₂, which can be greater than R₁, from axis of rotation 12.

The number of openings 50 within the interconnected web 40 can vary. For example, the interconnected web 40 can have five differently sized openings patterned 16 times for a total of 80 cells. In yet other embodiments, other numbers of openings 50 can be used other than 16. For example, in preferred embodiments, the interconnected web 40 could include between 12 and 64 patterns of cells. Other numbers outside of this range are also possible.

As shown in FIGS. 4D and 4E, openings in a radially inner layer 56 can be similarly shaped as compared to those in a radially outer layer 58 but can be sized differently from those openings, such that the generally polygonal openings 50 increase in size when moving from opening to opening in a radially outward direction. However, turning to FIG. 4G, a second plurality of generally polygonal openings 51 in a radially outer layer 58 can also be smaller than those in a first plurality of generally polygonal openings 50 in a radially inner layer 56. In addition, the second plurality of generally polygonal openings can be either circumferentially separated from each other by a third plurality of generally polygonal openings 53 or can be greater in number than the first plurality of generally polygonal openings 50, or it can be both.

As noted above, FIGS. 4-4F show several variations of a plurality of generally polygonal openings 50 that are generally hexagonally shaped. As shown, these openings can be symmetrical in one direction or in two directions, or, in another embodiment, they are not symmetrical. For example, in FIG. 4A, radial symmetry planes 14 bisect several of the plurality of generally polygonal openings 50. Those openings are generally symmetrical about radial symmetry planes 14. However, interconnected web 40 of run-flat device 10 can also be generally symmetrical as a whole about radial symmetry planes. In comparison, a second plurality of generally polygonal openings 14 can be generally symmetrical about similar radial symmetry planes 14. In addition, as shown in FIGS. 4D and 4E, a second plurality of generally polygonal openings can be generally symmetrical about lines tangent to a cylinder commonly centered with axis of rotation 12, providing a second degree of symmetry.

The web elements 42 can have significantly varying lengths from one embodiment to another or within the same embodiment. For example, the interconnected web 40 in FIG. 4D comprises web elements 42 that are generally shorter than web elements of the interconnected web shown in FIG. 4C. As a result, interconnected web 40 can appear denser in FIG. 4D, with more web elements 42 and more generally polygonal openings 50 in a given arc of run-flat device 10. In comparison, FIGS. 4F and 4G both show interconnected webs 40 with web elements 42 that substantially vary in length within the same interconnected web. In FIG. 4F, radially inward web elements 42 are generally shorter than web elements 42 located comparatively radially outward. However, FIG. 4G shows radially inward web elements 42 that are substantially longer than its radially outward web elements 42. As a result, interconnected web 40 of FIG. 4F appears more inwardly dense than interconnected web 42 of FIG. 4G.

Remaining with FIG. 4G, an interconnected web 40 is shown such that web elements 42 define a radially inner layer 56 of generally polygonal openings 50 that is significantly larger than a radially outer layer 58 of generally polygonal openings 50. Radially inner layer 56 can comprise alternating wedge-shaped openings 55 that may or may not be similarly shaped. As shown, a second plurality of generally polygonal openings 51 can be separated from first plurality of generally polygonal openings 50 by a generally continuous web element 42 of interconnected web 40 spaced at a generally constant radial distance from the axis of rotation 12. The generally continuous, generally constant web element 42 can assist in providing further stiffness to the non-pneumatic tire 10 in regions that are resistant to deformation.

With reference to FIGS. 4-4H, the combination of the geometry of interconnected web 40 and the material chosen in interconnected web 40 can enable an applied load, L, to be distributed throughout the web elements 42. Because the web elements 42 are preferably relatively thin and can be made of a material that is relatively weak in compression, those elements 42 that are subjected to compressive forces may have a tendency to buckle. These elements are generally between the applied load, L, that generally passes through axis of rotation 12 and the footprint region.

In one embodiment, some or all of the web elements 42 can be provided with weakened (e.g., previously bent) or thinned sections, such that the web elements 42 preferentially bend and/or are biased to bend in a certain direction. For example, in one embodiment, the web elements are biased such that they bend generally in an outwardly direction. In this manner, web elements do not contact or rub against each other as they buckle. In addition, the position of the weakened or thinned portion can be used to control the location of the bending or buckling to avoid such contact.

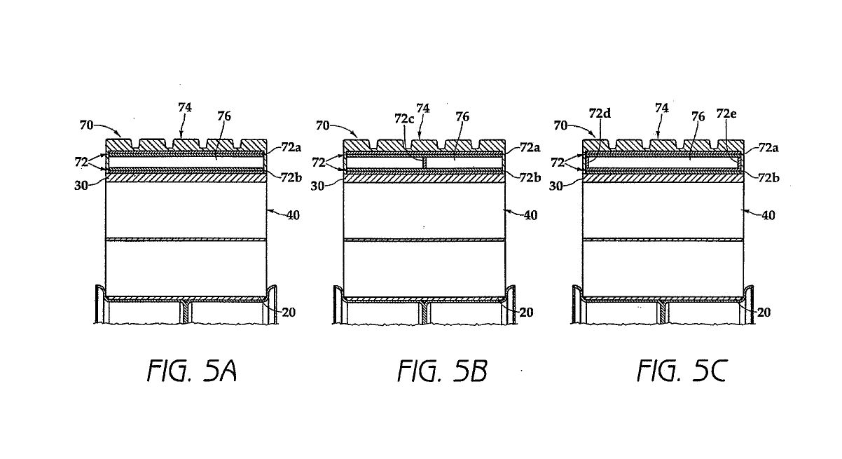

When buckling occurs, the remaining web elements 42 may experience a tensile force. It is these web elements 42 that support the applied load L. With reference to FIGS. 5A-5C, although relatively thin, because web elements 42 can have a high tensile modulus, E, they can have a smaller tendency to deform, but instead can help maintain the shape of a tread carrying layer 70 or outer ring 30. In this manner, the tread carrying layer 70 and/or outer ring 30 can support the applied load L on the device 10 as the applied load L is transmitted by tension through the web elements 42. The tread carrying layer 70 and/or outer ring 30, in turn, acts as an arch and provides support. Accordingly, the tread carrying layer 70 and/or outer ring 30 is preferably sufficiently stiff to support the web elements 42 that are in tension and supporting the load L. Preferably, a substantial amount of said applied load L is supported by the plurality of said web elements working in tension. For example, in one embodiment, at least 75% of the load is supported in tension, in another embodiment at least 85% of the load is supported in tension and in another embodiment at least 95% of the load is supported in tension with the balance in compression. In other embodiments, less than 75% of the load can be supported in tension.

With reference to FIG. 4, although the generally annular inner ring 20, the generally annular outer ring 30, and the interconnected web 40 can be comprised of the same material; they can all have different thicknesses. That is, the generally annular inner ring can have a first thickness, tᵢ; the generally annular outer ring can have a second thickness, tₒ; and the interconnected web can have a third thickness, tₑ. As shown in FIG. 4, in one embodiment, the first thickness tᵢ can be less than the second thickness tₒ. However, the third thickness, tₑ, can be less than either first thickness, tᵢ, or the second thickness, tₒ. This illustrated arrangement is presently preferred, as a thinner web element 42 buckles more easily when subjected to a compressive force, whereas a relatively thicker generally annular inner ring 20 and the generally annular outer ring 30 can advantageously help maintain lateral stiffness of the run-flat device 10 in an unbuckled region by better resisting deformation. In another embodiment, the thickness of the web tₑ can vary within the web 40. For example, in one embodiment, the web thickness tₑ decreases as the radial distance from the center of the device 10 is increased such that the web provides increasing resistance as it is deformed inwardly. In other embodiments, this relationship is reversed. In still other embodiments, the web is thicker or thinner in the radially middle portions as compared to the inner and outer portions of the web 40.

The thickness, tₑ, of web elements 42 can vary, depending on predetermined load capability requirements. For example, as the applied load, L, increases, the web elements 42 can increase in thickness, tₑ, to provide increased tensile strength, reducing the size of the openings in the plurality of generally polygonal openings 50. However, the thickness, tₑ, should not increase too much so as to inhibit buckling of those web elements 42 subject to a compressive load. However, in certain embodiments (as described above), it can be desirable to have some or a significant amount of the load supported by the web elements 42 in compression. In such embodiments, the thickness, tₑ can be increased and/or the shape of the web elements 42 changed so as to provide resistance to a compressive load. In addition, the material selection can also be modified so as to provide for the web elements supporting a compressive load.

As with choice of material, the thickness, tₑ, can increase significantly with increases in the applied load L. For example, in certain non-limiting embodiments, each web element 42 of interconnected web 40 can have a thickness, tₑ between about 0.04 and 0.1 inches for device loads of about 0-1000 lbs, between about 0.1 and 0.25 inches for loads of about 500-5000 lbs, and between 0.25 and 0.5 inches for loads of about 2000 lbs or greater. Those of skill in the art will recognize that these thicknesses can be decreased or increased in modified embodiments.

In addition to the web elements 42 that are generally angled relative to radial planes 16 passing through the axis of rotation 12, the interconnected web 40 can also include tangential web elements 45, as shown in FIGS. 4-4F. The tangential web elements 45 can be oriented such that they are generally aligned with tangents to cylinders or circles centered at the axis of rotation 12. The tangential web elements 45 are preferred because they assist in distributing applied load, L. For example, when the applied load, L, is applied, the web elements 42 in a region above axis of rotation 12 are subjected to a tensile force. Without the tangential web elements 45, interconnected web 40 may try to deform by having the other web elements 42 straighten out, orienting themselves in a generally radial direction, resulting in stress concentrations in localized areas. However, by being oriented in a generally tangential direction, the tangential web elements 45 distribute the applied load, L, throughout the rest of interconnected web 40, thereby minimizing stress concentrations.

Staying with FIGS. 4-4F, the plurality of generally polygonal openings 50 are shown wherein each one of said plurality of generally polygonal openings 50 is radially oriented. As noted above, the generally polygonal openings 50 can be oriented such that they are symmetrical about radial symmetry planes 14 that pass through axis of rotation 12. This arrangement can facilitate installation by allowing device 10 still to function properly even if it is installed backwards, because it should behave in the same manner regardless of its installed orientation.

FIG. 4H shows a perspective view of an embodiment where the run-flat device 10 comprises a plurality of segments 18. Each segment 18 can have a generally uniform width, W_{S}, but each also can have different widths in modified embodiments. The segments 18 can be made from the same mold so as to yield generally identical interconnected webs 40, but they can also be made from different molds to yield varying patterns of interconnected webs 40.

The choice of materials used for interconnected web 40 may be an important consideration. In one embodiment, the material that is used will buckle easily in compression, but be capable of supporting the required load in tension. Preferably, the interconnected web 40 is made of a cross-linked or uncross-linked polymer, such as a thermoplastic elastomer, a thermoplastic urethane, or a thermoplastic vulcanizate. More generally, in one embodiment, the interconnected web 40 preferably can be made of a relatively hard material having a Durometer measurement of about 80A-95A, and/or in one embodiment 92A (40D) with a high tensile modulus, E, of about 21 MPa or about 3050 psi or in other embodiments between about 1000 psi to about 8000 psi. However, tensile modulus can vary significantly for rubber or other elastomeric materials, so this is a very general approximation. In addition, Durometer and tensile modulus requirements can vary greatly with load capability requirements.

The polymer materials discussed above for the interconnected web 40, the inner ring 20, and/or the outer ring 30 additionally can include additives configured to enhance the performance of the device 10. For example, in one embodiment, the polymer materials can include one or more of the following: antioxidants, light stabilizers, plasticizers, acid scavengers, lubricants, polymer processing aids, antiblocking additives, antistatic additives, antimicrobials, chemical blowing agents, peroxides, colorants, optical brighteners, fillers and reinforcements, nucleating agents, and/or additives for recycling purposes.

Other advantages can be obtained when using a polymer material such as polyurethane in the device 10 instead of the rubber of traditional devices. A manufacturer of the illustrated embodiments can need only a fraction of the square footage of work space and capital investment required to make rubber tires. The amount of skilled labor necessary can be significantly less than that of a rubber tire plant. In addition, waste produced by manufacturing components from a polyurethane material can be substantially less than when using rubber. This is also reflected in the comparative cleanliness of polyurethane plants, allowing them to be built in cities without the need for isolation, so shipping costs can be cut down. Furthermore, products made of polyurethane can be more easily recyclable.

Cross-linked and uncross-linked polymers, including polyurethane and other similar nonrubber elastomeric materials can operate at cooler temperatures, resulting in less wear and an extended fatigue life of device 10. For example, polyurethane has good resistance to ozone, oxidation, and organic chemicals, as compared to rubber.

In other embodiments, the interconnected web 40 comprises web elements 42 that also contain strengthening components 46 such as carbon fibers, KEVLAR®, and/or some additional strengthening material to provide additional tensile strength to the interconnected web 40. Properties of the strengthening components 46 for certain embodiments can include high strength in tension, low strength in compression, light weight, good fatigue life, and/or an ability to bond to the material(s) comprising the interconnected web 40.

FIG. 4I illustrates another modified embodiment. In this embodiment, the width wₒ varies along the circumference of the outer ring 30. Specifically, in this embodiment, the outer ring 30 is thicker at portions that are connected to a web element 42 and thinner between web elements 42. In this manner, the weight of the outer ring 30 and material used can be reduced. In other embodiments, it is anticipated that the inner ring 20 and/or web elements 42 can also have varying widths along their respective circumferences. In other embodiments, the inner ring 20, outer ring 30 and web element 40 can also have varying widths with respect to each other. For example, in one embodiment the web element 40 has a smaller width than the outer and inner rings 30, 20. In yet another embodiment, the web element 40 has a width that varies radially with respect to the longitudinal axis of the device. For example, in one embodiment, the width is wider near the outer and inner rings 30, 20 as compared to the middle portions of the web element 40. In other embodiments, this relationship can be reversed.

FIGS. 5A-5C show several possible examples of the arrangement of the reinforcing belts 72 in the tread carrying layer 70. FIG. 5A is a version showing a tread 74 at a radially outermost portion of the device 10. Moving radially inwardly are a plurality of reinforcing belts 72a, a layer of support material 76, which forms a shear layer, and a second plurality of reinforcing belts 72b. In this embodiment, the reinforcing belts 72a, 72b are arranged so that each belt is a generally constant radial distance from the axis of rotation 12.

Turning to the embodiment of FIG. 5B, a tread carrying layer 70 similar to that of FIG. 5A is shown. However, the embodiment of FIG. 5B shows the layer of support material 76 being approximately bisected in a generally radial direction by at least one transverse reinforcing belt 72c. Support material 76 can be a rubber, polyurethane, and/or similar compound, such that as a footprint is formed by the device, the support material 76 between the reinforcing belts 72 is subjected to a shear force. Thus, the support layer 76 provides the tread carrying layer 70 with increased stiffness.

The tread carrying layer 70 of FIG. 5C resembles that of FIG. 5A but comprises two additional groupings of reinforcing belts 72. In addition to the generally radially constant plurality of reinforcing belts 72a, 72b, the tread carrying layer 70 in FIG. 5C includes transverse reinforcing belts 72d, 72e. The transverse reinforcing belts 72d, 72e include at least one reinforcing belt 72d proximate a longitudinally inner surface and at least one reinforcing belt 72e proximate a longitudinally outer surface, such that reinforcing belts 72a, 72b, 72d, 72e generally enclose a layer of support material 76 in a generally rectangular box shape.

The reinforcing belts 72 and the support material 76 as described above generally form a shear layer. As a footprint is formed by the device, the support material 76 between the reinforcing belts is subjected to a shear force. Thus, the support layer 75 provides the tread carrying layer with increased stiffness.

In one embodiment, the shear layer (support material) 76 has a thickness that is in the range from about 0 inches (i.e., no shear layer) to about 1 inch think (as measured along a radius extending from the axis of rotation). In other heavy load applications, the shear layer 76 can have a thickness greater than 1 inch.

The interconnected web 40, the generally annular inner ring 20, and the generally annular outer ring 30 can be molded all at once to yield a product that has a width or depth of the finished non-pneumatic device. However, the interconnected web 40, the generally annular inner ring 20, and the generally annular outer ring 30 can be manufactured in steps and then assembled.

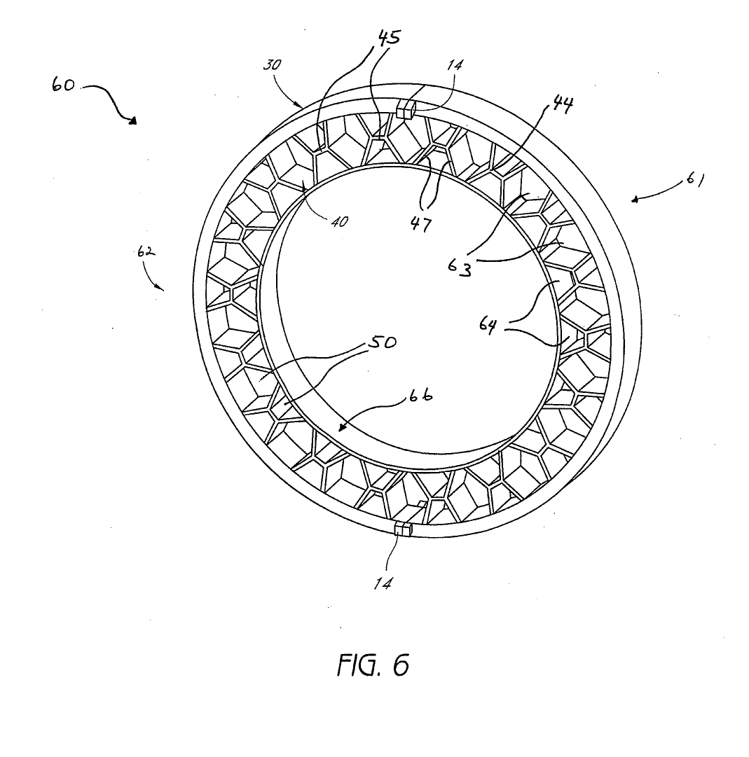

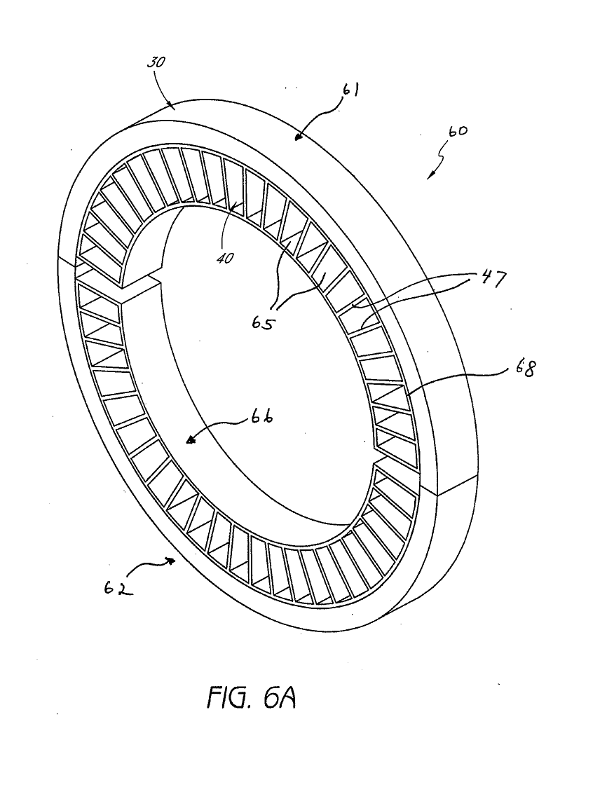

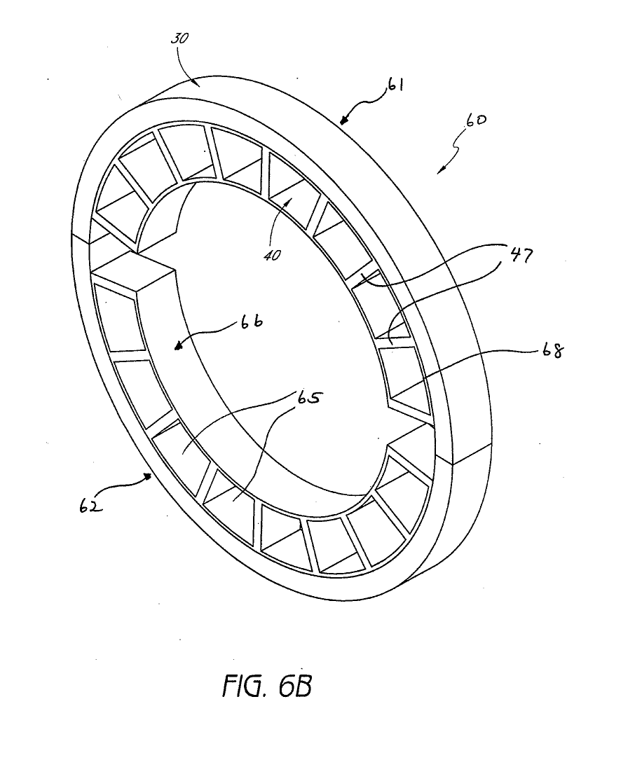

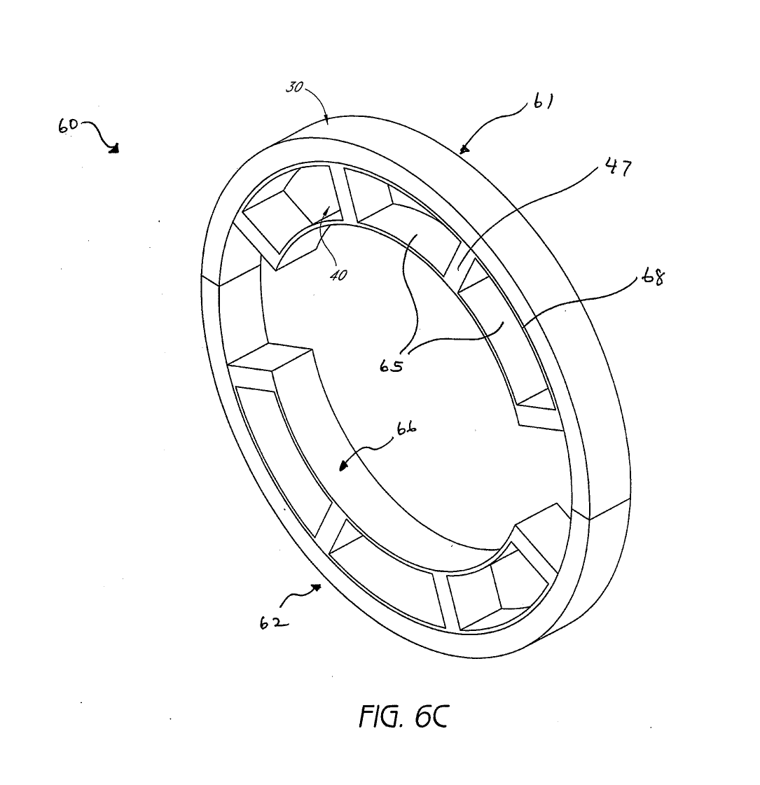

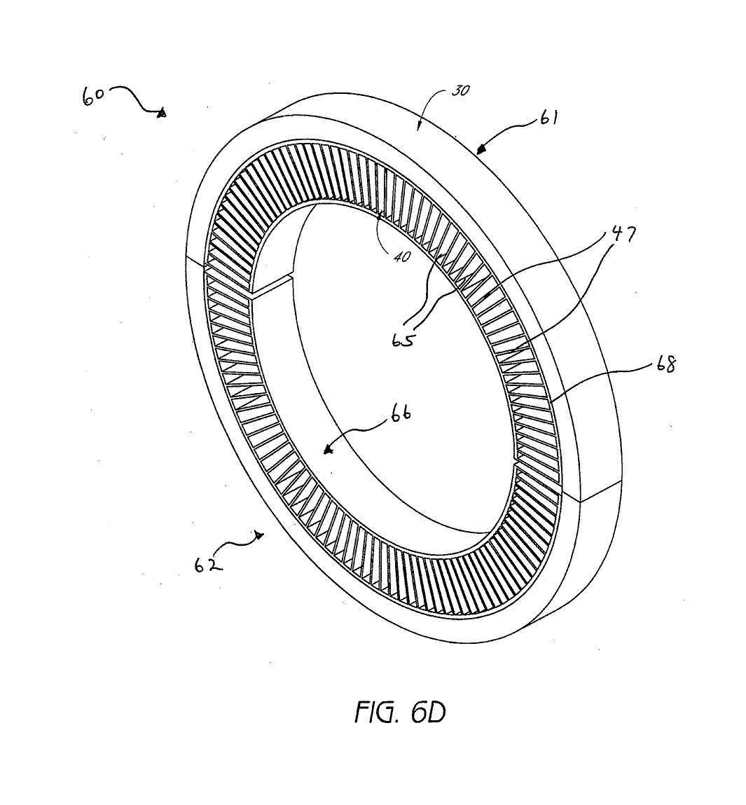

With reference to FIGS. 6-6D, in at least one embodiment the interconnected web 40 and generally annular outer ring 30 can be formed from one continuous material. For example, the web 40 and outer ring 30 can be cast or injection molded as a unitary piece 60 from a material such as plastic or urethane. Other materials can also be used. By forming the web 40 and outer ring 30 from one material, the bonding surfaces between the web 40 and outer ring 30 can be reduced or eliminated, which can be advantageous for providing structural strength and rigidity to the run flat device 10. Forming the web 40 and outer ring 30 as one unit can facilitate ease of manufacturability. In an embodiment illustrated in FIG. 6, the unitary piece 60 comprises a first unitary piece 61 and a second unitary piece 62 that are semicircular unitary pieces that can be fastened together at flanges 14 to form a circular unitary piece 60. In other embodiments, the unitary piece can comprise more than two pieces that join together to form a circular unitary piece 60.

With further reference to FIG. 6, the embodiment illustrates a web 40 comprising polygonal openings 50 that are generally hexagonally shaped, similar to the discussion above for FIGS. 4-4H. However, in the embodiment of FIG. 6, the generally hexagonal openings 63 extend from the inner circumference 66 of the web 40 to the outer ring 30. In other words, the inner circumference 66 defines the radially inner side of the generally hexagonal opening 63 and the outer ring 30 defines the radially outer side of the generally hexagonal opening 63. The distance between the inner circumference 66 and the outer ring 30 is spanned by two radial web elements 47 that are joined at an intersection 44. The radial web elements 47 extend at an angle from a radial plane 16, as illustrated in FIG. 6, to form the sides of the generally hexagonal opening 63.

The radial web elements 47 are connected at their intersections 44 by tangential web elements 45, forming two generally trapezoidal openings 64 between the generally hexagonal openings 63, as illustrated in FIG. 6. The tangential web elements 45 define the minor parallel side of the generally trapezoidal openings 64 and the inner circumference 66 and the outer ring 30 define the bases of the generally trapezoidal openings 64. The angled sides of the generally trapezoidal opening are defined by the radial web elements 47.

FIG. 6A illustrates an embodiment of a unitary piece 60 with a plurality of generally rectangular openings 65 defined by a plurality of radial web elements 47 interconnecting an inner circumference of the web 40 with an outer circumference 68 of the web 40. In the embodiment illustrated in FIG. 6A, the radial web elements 47 are generally parallel with the radial plane 16 at each location around the web 40. In other embodiments, the radial web elements 47 can be at an angle to the radial plane 16. FIG. 6A illustrates the first and second unitary pieces 61, 62 each having twenty-three generally rectangular openings 65. However, in other embodiments, as discussed below, the first and second unitary pieces 61, 62 can have more or less generally rectangular openings 65.

FIG. 6B illustrates another embodiment of a unitary piece 60 similar to the embodiment of FIG. 6A, but with eight generally rectangular openings 65 on each of the first and second unitary pieces 61, 62. There are a fewer number of radial web elements 47 in this embodiment, but the thickness of the radial web elements 47 are greater compared to the radial web elements 47 in FIG. 6A, which can enable each radial web element 47 to withstand greater loads. In other embodiments, however, the radial web elements 47 of FIG. 6B can have a thickness similar to the radial web elements of FIG. 6A.

FIG. 6C illustrates yet another embodiment of a unitary piece 60 having only three generally rectangular openings 65 on the first and second unitary pieces 61, 62. The radial web elements 47 in this embodiment are thicker than either of the radial web elements 47 of FIG. 6A or 6B. However, in other embodiments, the thickness of the radial web elements 47 can be the same as the thickness of the radial web elements 47 of FIG. 6A or 6B.

The embodiment of FIG. 6D illustrates yet another embodiment of a unitary piece 60 with fifty-seven generally rectangular openings 65 on each of the first and second unitary pieces 61, 62. The radial web elements 47 in this embodiment are thinner than any of the radial web elements 47 of FIGS. 6A-C. In other embodiments, the thickness of the radial web elements 47 can be the same as the thickness of the radial web elements 47 of FIGS. 6A-C.

In some embodiments, fibers in the web 40 and/or outer ring 30 can add structural rigidity to the injection molded material which forms the integrally formed web 40 and outer ring 30. Also, in some embodiments, the urethane or other injection grade material forming the outer ring 30, can provide more resiliency to applied forces and absorb more of the impact than compared to a rigid metal outer ring.

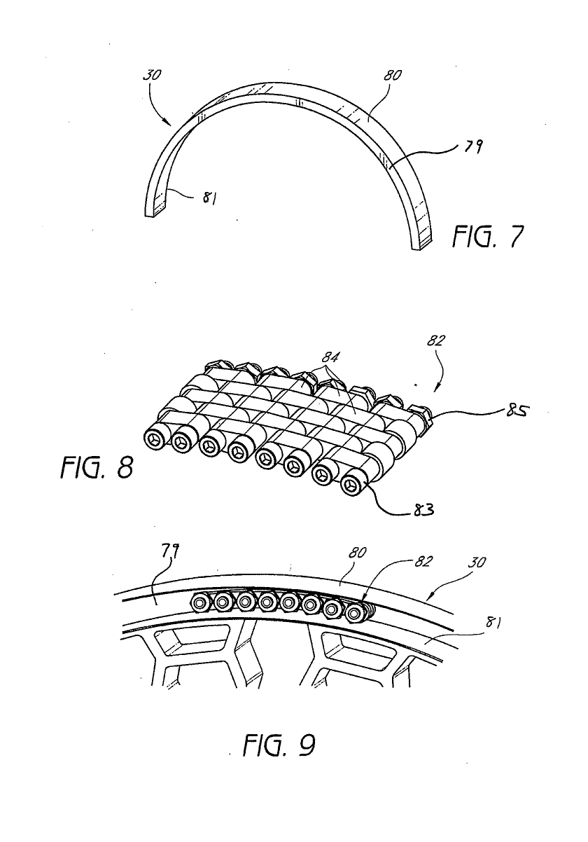

With reference to FIG. 7, in some embodiments the outer ring 30 can comprise a middle portion 79 made, for example, of a urethane or plastic material, interposed between an outer element 80 secured to the radial outside surface of the middle portion 79 and an inner element 81 secured to the radial inside surface of the middle portion 79. In some embodiments, the outer and/or inner elements 80, 81 can be spring steel elements. The spring steel elements 80 can provide added stiffness to the outer ring 30, as well as preserve some flexibility to the run-flat 10, such that the run-flat 10 and outer ring 30 can rebound more quickly from an impact hit as compared to a run-flat 10 with only a urethane outer ring. In other embodiments, the outer and/or inner elements 80, 81 can be any other material known in the art that can provide stiffness while preserving some flexibility.

With reference to FIGS. 8 and 9, in some embodiments the run-flat 10 can include a flexible link element 82. The flexible link element 82 can comprise a plurality of links 84 which are coupled (e.g. hinged) to one another to provide the link element 82 with flexibility in at least one degree of freedom. Each link 84 can comprise two through holes wherein elongate screws 83 can pass to couple two or more links 84 together. In the embodiment illustrated in FIGS. 8 and 9, the screws 83 couple five links 84 together. The links 84 are held secured to the screw 83 by a nut 85 that attaches to the end of the screw 83. In some embodiments, the links 84 can be made of a metal. In other embodiments, the links 84 can be made of other materials, such as plastics or composites.

As illustrated in FIG. 9, the link element 82 can be embedded in the outer ring 30. In some embodiments, the link element 82 can be embedded in the middle portion 79 of the outer ring 30. The link element 82 can be extend partially or entirely around the run-flat 10, and can provide added stiffness and/or flexibility to the run-flat 10 and outer ring 30. In some embodiments, the link element 82 can extend partially or entirely around the run-flat 10 and join and/or hold pieces 32 and 34 of the outer ring 30 together. With the pieces 32 and 34 of the outer ring 30 held together, the link element 82 can provide a flexible joint section that can withstand impacts to the tire.

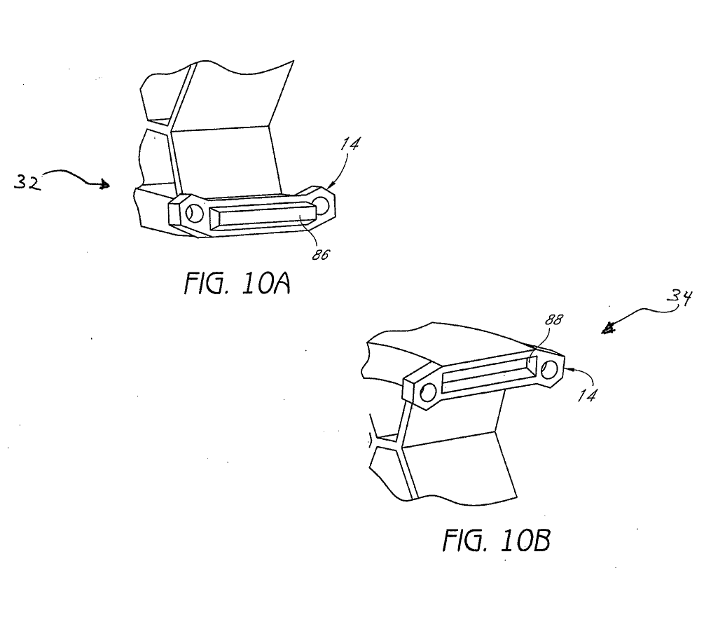

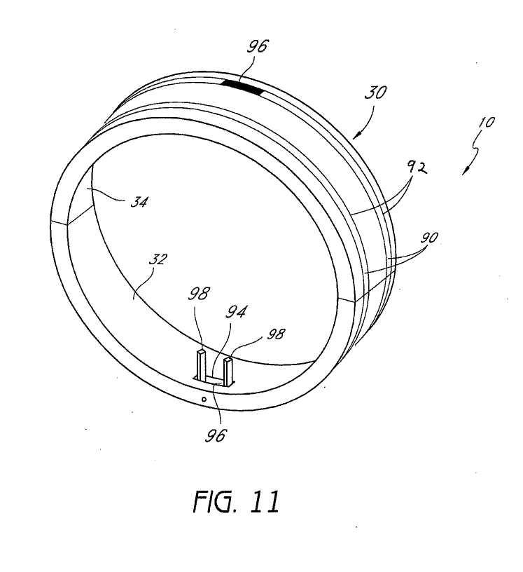

The outer ring 30, as described above and illustrated in FIG. 1, can comprise pieces 32, 34 which are held together by fasteners (e.g. bolts) to form the outer ring 30. The pieces 32, 34 can comprise bolt flanges 14 for accepting the fasteners. As illustrated in FIGS. 10A and 10B, in some embodiments the bolt flanges 14 can comprise a tab 86 and/or pocket 88. In some embodiments, the tabs 86 and pockets 88 can have an interference fit, which can enable the tabs 86 and pockets 88 to transmit radial forces. In other words, the tabs 86 and pockets 88 can carry at least a portion of any shear stress experienced by the outer ring 30 during use of the run-flat 10. In some embodiments, the tabs 86 and pockets 88 can comprise generally rectangular shapes, such as those shown in FIGS. 10A and 10B. Other embodiments can comprise different quantities, sizes, and/or shapes of the tabs 86 and pockets 88.

With reference to FIG. 11, in some embodiments the outer ring 30 can comprise at least one cable 90, which is preferably made of steel. The steel cable 90 can be used to hold the pieces 32, 34 together In the embodiment illustrated in FIG. 11, two steel cables 90 are wrapped around the pieces 32, 34. The cables can rest on an exterior portion of the outer ring 30, or can be nested within preformed grooves or channels 92 that extend along the outer circumference of the outer ring 30. The pieces 32, 34 can have openings 94 through which the cables 90 can be pulled. The cables 90 can be held together (e.g. tightened) by a tightening device 96, such as for example a wedge-like structure which can frictionally engage and hold ends 98 of the cables 90 together.

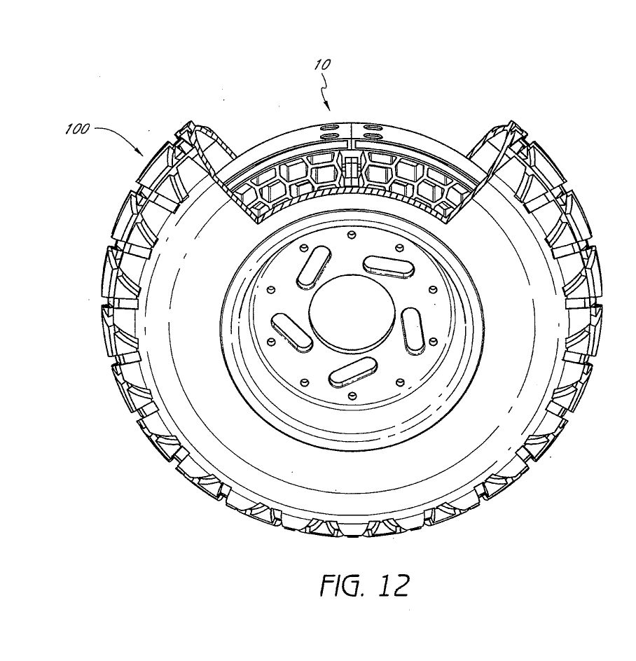

With reference to FIG. 12, the run-flat 10 can be inserted into a conventional pneumatic tire 100 such that the run-flat 10 holds the beads of the tire 80 in place and remains hidden underneath the tire 100 during use of the tire 100. If the tire 100 suffers a puncture, damage, or in any way fails and deflates, the run-flat 10, and its outer ring 30 and web structure 40, can allow the tire 100 to remain running for an extended period of time.

If the tire 100 does not have a sidewall and becomes deflated, the generally annular outer ring 30, combined with the interconnected web 40, can also add lateral stiffness to the assembly.

A major advantage of the run-flat device 10 is the removal of mass by using an interconnected web 40 to transmit loads applied by a vehicle. This decreased weight can improve fuel economy and the air transportability of the vehicle, both being key properties to the military. In addition, by transmitting vibration and shock to the web 40, the ride can be less harsh.

The run-flat device 10 can exhibit many of the same characteristics of the current run-flat device. For example, it can demonstrate similar ability to carry loads; can have the ability to function when surrounding pneumatic tires fail; can have costs for given performances that are similar to traditional run-flat devices. However, the run-flat device of the present application can have a better ride than current run-flat devices; can be easier to assemble than single piece run-flat devices; can have lower weight than solid run-flat devices; and can transfer less road vibration and shock than current run-flat devices.

While the foregoing written description of embodiments of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiment and method, but by all embodiments and methods within the scope and spirit of the invention as claimed.

What is claimed is:

1. A run-flat device for use with a pneumatic tire comprising:
an inner ring having an axis of rotation, the inner ring comprising at least two annular pieces;
a deformable outer ring comprising at least two annular pieces; and
a flexible interconnected web extending between the inner and outer ring and comprising at least two annular pieces, the interconnected web comprising at least two radially adjacent layers of web elements at every radial cross-section of the run-flat device, the web elements defining a plurality of generally polygonal openings and comprising at least one radial web element that is angled relative to a plane that extends radially through the axis of rotation; wherein a substantial amount of load is supported by a plurality of the web elements working in at least in part tension when the run-flat device is in direct contact with the ground.

2. A run-flat device according to claim 1, further comprising a run-flat device tread carrying layer coupled to a radially external surface of the outer ring.

3. A run-flat device according to claim 1, wherein the plurality of generally polygonal openings comprises a first plurality of generally polygonal openings having a first shape and a second plurality of generally polygonal openings having a second shape different from the first shape.

4. A run-flat device according to claim 3, wherein at least one of the first plurality of generally polygonal openings and at least one of said second plurality of generally polygonal openings are traversed when moving in any radially outward direction from the axis of rotation.

5. A run-flat device according to claim 3, wherein each of the first plurality of generally polygonal openings has a first inner boundary spaced at a first radial distance and each of the second plurality of generally polygonal openings has a second inner boundary spaced at a second, greater radial distance.

6. A run-flat device according to claim 5, wherein at least one generally polygonal opening of the first plurality of generally polygonal openings is larger than at least one generally polygonal opening of the second plurality of generally polygonal openings.

7. A run-flat device according to claim 1, wherein the plurality of generally polygonal openings are generally hexagonally shaped.

8. A run-flat device according to claim 1, wherein the inner ring, outer ring and flexible interconnected web are formed into a unitary structure.

9. A run-flat device according to claim 1, wherein the inner ring comprises a metal material and the outer ring and flexible interconnected web comprise a polymer.

10. A run-flat device according to claim 1, wherein the flexible interconnected web and outer ring are formed as a unitary piece.

11. A run-flat device according to claim 1, wherein the outer ring comprises a layer of rigid material on a radially inner surface and/or radially outer surface.

12. A run-flat device according to claim 1, wherein the outer ring comprises a link element.

13. A run-flat device according to claim 1:
further comprising bolt flanges on the two annular pieces, the bolt flanges having at least one tab and/or one pocket;
wherein the bolt flanges are held together by fasteners.

14. A run-flat device according to claim 1, wherein the two annular pieces are held together by at least one cable.

15. A pneumatic tire comprising:
a rim;
an annular inner ring coupled to the rim;
an interconnected web coupled to the inner ring, the interconnected web comprising a plurality of polygonal shaped web elements and openings, the polygonal shaped web elements being stronger in tension than in compression;
an annular outer ring attached to the interconnected web on a side of the interconnected web opposite that of the annular inner ring, the annular outer ring comprising a deformable material; and
an external pneumatic tire operatively coupled to the rim.

16. The pneumatic tire according to claim 15, wherein the interconnected web and annular outer ring are configured to support an applied load if the pneumatic tire becomes deflated.

17. The pneumatic tire according to claim 15, further comprising a run-flat device coupled to a radially external surface of the outer ring.

18. A run-flat device according to claim 15, wherein the plurality of generally polygonal openings comprises a first plurality of generally polygonal openings having a first shape and a second plurality of generally polygonal openings having a second shape different from the first shape.

19. A run-flat device according to claim 18, wherein at least one of the first plurality of generally polygonal openings and at least one of said second plurality of generally polygonal openings are traversed when moving in any radially outward direction from the axis of rotation.

20. A run-flat device according to claim 18, wherein each of the first plurality of generally polygonal openings has a first inner boundary spaced at a first radial distance and each of the second plurality of generally polygonal openings has a second inner boundary spaced at a second, greater radial distance.

21. A run-flat device according to claim 18 wherein at least one generally polygonal opening of the first plurality of generally polygonal openings is larger than at least one generally polygonal opening of the second plurality of generally polygonal openings.

22. A run-flat device according to claim 15, wherein the plurality of generally polygonal openings are generally hexagonally shaped.

23. A run-flat device according to claim 15, wherein each of the inner ring, outer ring and interconnected web are formed into at least two annular pieces.

24. A run-flat device according to claim 15, wherein the inner ring and holds a bead of the pneumatic tire in compression between the inner ring and the rim.

25. A run flat device according to claim 15, wherein the inner ring, outer ring and flexible interconnected web are a unitary structure.
